(19) United States
(12) Patent Application Publication
(10) Pub. No.: US 2010/0161736 A1
(43) Pub. Date: Jun. 24, 2010

(54) METHODS, SYSTEMS, AND COMPUTER PROGRAM PRODUCTS FOR IMPLEMENTING A COMMUNICATION SERVICE

(75) Inventor: Peter A. Picknelly, Springfield, MA (US)

Correspondence Address: CANTOR COLBURN, LLP, 20 Church Street, 22nd Floor, Hartford, CT, 06103, US

(73) Assignee: Forever Cards, LLC, Springfield, MA (US)

(21) Appl. No.: 12/342,539

(22) Filed: Dec. 23, 2008

(51) Int. Cl. G06F 15/16

(52) U.S. Cl. 709/206

(57) ABSTRACT

Methods, system, and computer program products for implementing a communication service are presented. The communication service provides customized communications on behalf of subscribers to the communication service. A method includes defining an event, the occurrence of which forms a first portion of a condition for executing a communication. The method also includes providing a destination for delivery of the communication. The method further includes configuring elements of the communication, which include content and a transmission date. The transmission date forms a second portion of the condition for executing the communication. The method further includes monitoring sources of information for the event and, upon determining the condition has been met, generating the communication using the configured elements and sending, on the transmission date, the communication to the destination.

### BACKGROUND

The present invention relates generally to communications services, and more particularly, to a communications system and service that enable individuals, through pre-defined communications, to sustain a relationship with loved ones when they are no longer physically able to do so themselves.

With the advent of the Internet revolution, people in society are able to stay connected with friends, family, and loved ones in ways never before thought possible. Before the Internet age, factors such as prohibitive costs associated with long distance telephone services, as well as time delays and a lack of real-time interactivity of the postal mail system, made it difficult for people to stay in touch and remain ‘emotionally connected.’ Today, however, individuals who live thousands of miles apart can now easily, inexpensively, and in near real time communicate over a data network connection using messaging tools, video Web cameras, personal Web pages, and video conferencing techniques, to name a few. The ubiquitous nature of the Internet, as well as its relative ease of use and cost efficiencies, has enabled millions of people around the world to create, sustain, and even grow personal relationships and emotional bonds with others.

Similarly, many individuals seek ways in which they can remain connected with their loved ones even after they have passed on, e.g., by using various digital recording technologies. In recent years, it has become increasingly common for people who have been diagnosed with a terminal illness to prepare video and/or audio recordings of themselves, which are passed on to their loved ones post mortem. These recordings can be source of comfort and solace to those left behind, particularly young children who would not otherwise have an opportunity to learn about their parents, grandparent, or ancestry, and they may even provide guidance designed to help the children persevere through anticipated difficult times. These recordings may also be considered a ‘treasure’ to families of those who have been diagnosed with a long-term chronic, incapacitating illness, such as Alzheimer's disease or other progressive debilitating illness in which family members oftentimes suffer the effects of a slow-growing, physical and emotional ‘disconnection’ from the ill person, as the ill person loses his/her ability to communicate with loved ones.

It would be desirable to provide further options that enable individuals to sustain an emotional connection with their loved ones when they are no longer physically and/or mentally able to do so themselves.

### BRIEF SUMMARY

Exemplary embodiments include methods for implementing a communication service. The communication service provides customized communications on behalf of subscribers to the communication service. A method includes defining an event, the occurrence of which forms a first portion of a condition for executing a communication. The method also includes providing a destination for delivery of the communication. The method further includes configuring elements of the communication, which include content and a transmission date. The transmission date forms a second portion of the condition for executing the communication. The method further includes monitoring sources of information for the event and, upon determining the condition has been met, generating the communication using the configured elements and sending, on the transmission date, the communication to the destination.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 depicts is a block diagram of a system upon which communication services may be implemented in accordance with exemplary embodiments;

FIG. 2 is a flow diagram describing a process for implementing the communication services in accordance with exemplary embodiments;

FIG. 3 depicts a user interface screen of the communication services in accordance with exemplary embodiments; and

FIG. 4 depicts a computer screen window of the user interface screen depicted in FIG. 3 in accordance with exemplary embodiments.

The detailed description explains the exemplary embodiments, together with advantages and features, by way of example with reference to the drawings.

### DETAILED DESCRIPTION OF EXEMPLARY EMBODIMENTS

In accordance with exemplary embodiments, communication services are provided. Through pre-defined communications, the services enable subscribers to sustain emotional relationships with loved ones when they are no longer able to do so due to, e.g., incapacitation or death. Once a subscriber has completed the subscription process, the communication services create a subscriber record and, using data from the record, periodically monitor sources of information to determine the subscriber's current condition (e.g., incapacitation or death). The sources of information may include a variety of electronic databases, messaging communications, and/or activity logs, to name a few. When the results of the monitoring indicate that the subscriber has become incapacitated or has passed on, the communication services retrieve information from a subscriber record to ascertain a date upon which transmission of the pre-defined communication will occur. The date may be associated with some occasion, such as a birthday, anniversary, graduation, holiday, or other event. The pre-defined communication is then delivered to a recipient pursuant to the subscriber record and in accordance with the transmission date. In an exemplary embodiment, the communication is a physical greeting card; however, it will be understood that other types of communications may be implemented in order to realize the advantages of the invention. In addition, the communication services may be configured such that a subscriber may select personal items or gifts (e.g., either in lieu of, or in addition to, the communication) to be delivered to the recipient on the pre-defined transmission date.

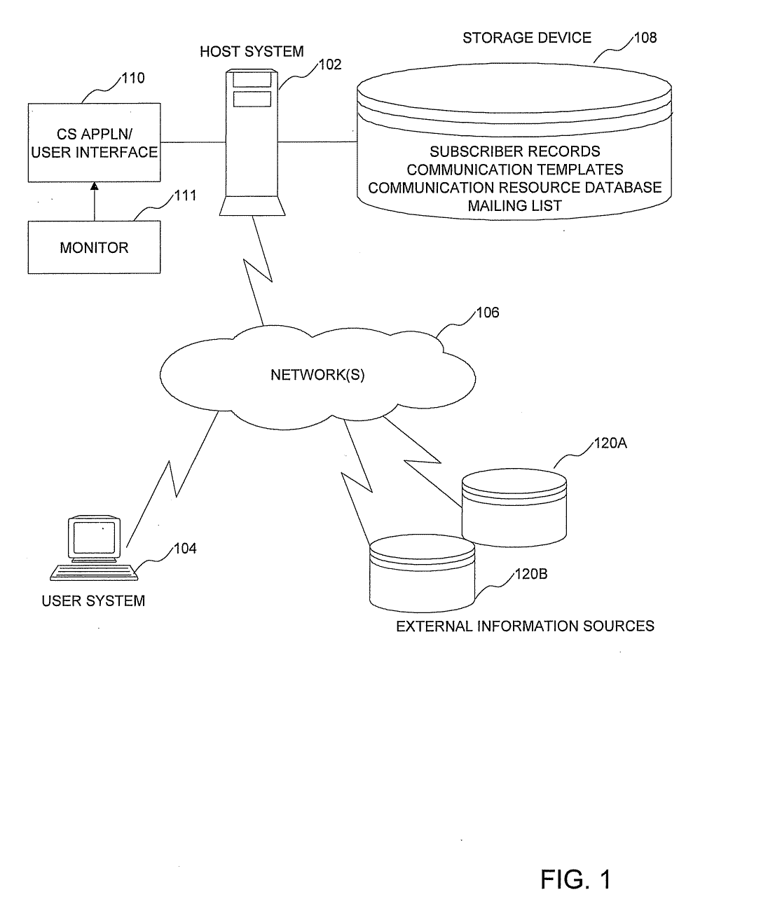

Turning now to FIG. 1, a block diagram of a system 100 upon which the communication services may be implemented in accordance with exemplary embodiments will now be described. In one exemplary embodiment, the system of FIG. 1 includes a host system 102 in communication with a user system 104 and one or more information sources 120 over one or more network(s) 106. The system 100 may be implemented by a business enterprise.

The user system 104 may be operated by a subscriber or potential subscriber of the communication services described herein. In an exemplary embodiment, the user accesses the host system 102 to initiate various features and functions of the communication services. The user system 104 may be implemented using a general-purpose computer executing a computer program for carrying out the processes described herein (e.g., the user system 104 may be operating a web browser). While only one user system 104 is shown in the system 100 of FIG. 1, it will be understood that many user systems 104 may be implemented in order to realize the advantages of the communication services.

The host system 102 may be implemented using one or more servers operating in response to a computer program stored in a storage medium accessible by the server(s). The host system 102 may operate as a network server (e.g., a web server) to communicate with the user system 104 and other network entities, e.g., a storage device 108. The host system 102 handles sending and receiving information to and from the user system 104 and can perform associated tasks. The host system 102 executes one or more enterprise applications in furtherance of the business goals of the enterprise. In an exemplary embodiment, the host system 102 also executes a communication service application 110. The communication service application 110 includes a monitor component 111 that searches information sources, such as the external information sources 120 and the storage device 108, as will be described herein.

The host system 102 is in communication with the storage device 108. The storage device 108 may be implemented using memory contained in the host system 102 or it may be a separate physical or logical device. In the exemplary embodiment shown in FIG. 1, the host system 102 is in direct communication with the storage device 108 (e.g., using physical cabling). In an alternative exemplary embodiment, the host system 102 may be in communication with the storage device 108 over the network(s) 106. It will be understood by one of ordinary skill in the art, however, that other network implementations may be utilized. For example, the storage device 108 may be logically addressable as a consolidated data source across a distributed environment that includes one or more of the networks 106. Information stored in the storage device 108 may be retrieved and manipulated via the host system 102. The storage device 108 stores a variety of information for use in implementing the communications services described herein. As shown in FIG. 1, e.g., the storage device 108 stores subscriber records, communication templates, communication resources, and mailing lists.

In an exemplary embodiment, external information sources 120 include a master database of deceased persons 120A and a searchable database of obituaries for a given geographical region 120B. The master database of deceased persons may be the Social Security Administration's Death Master File database, which provides a listing of deceased persons in the United States, as well as regular updates. The searchable database of obituaries may be determined by the communication services or may be provided by the subscriber. For ease of explanation, only a single searchable database of obituaries 120B is shown in FIG. 1. However, it will be understood by one of ordinary skill in the art that any number of such databases may be employed by the communication services in order to realize the advantages of the exemplary embodiments described herein. For example, if two subscribers from one region (e.g., city, county, etc.) each provide the service with two separate sources of obituary information, the communication services store the URLs (e.g., in the storage device 108) for each of these sources and may use both database sources of information to search for each subscriber. The monitor component 111 may be implemented as one or more online search scripts that use the selected URLs to periodically (e.g., daily) search corresponding sources for a particular subscriber name. The monitor component 111 will be described further herein.

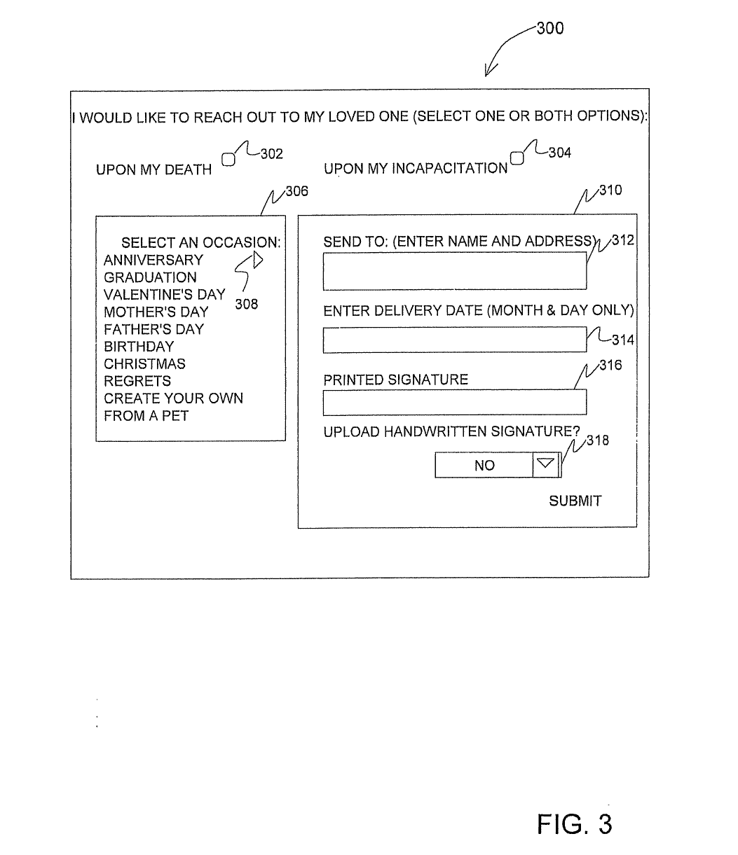

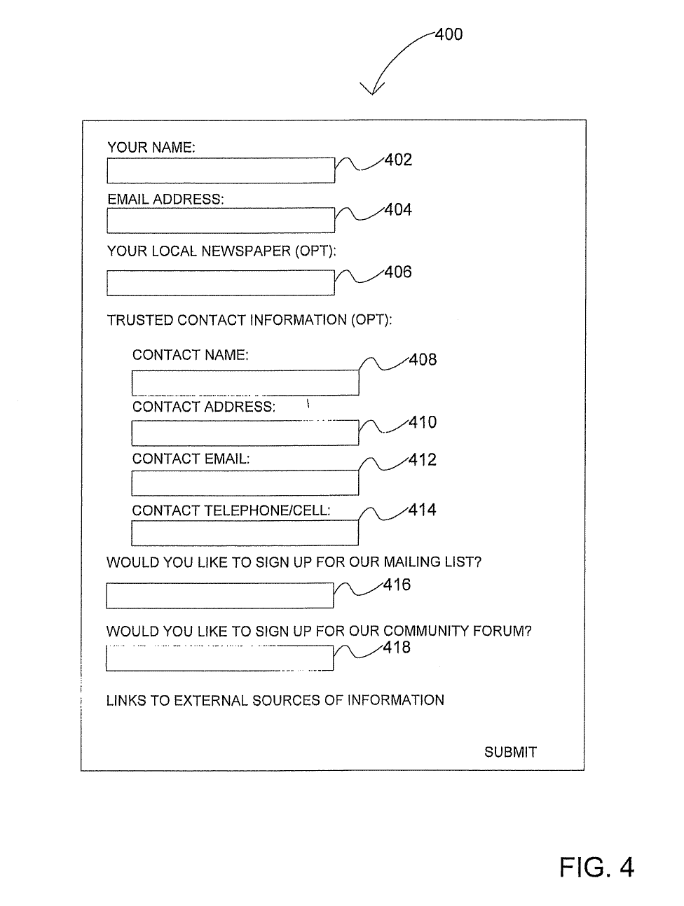

In an exemplary embodiment, the communication service application 110 includes a graphical user interface for enabling subscribers, or potential subscribers to access the features of the communication service application 110 including, e.g., creating, modifying, or deleting communications for designated recipients, updating information in a corresponding subscriber record, and accessing communication service resources (e.g., in the storage device 108). Sample user interface screens are shown generally in FIGS. 3 and 4.

Network(s) 106 may include any type of known network including, but not limited to, a wide area network (WAN), a local area network (LAN), a global network (e.g. Internet), a virtual private network (VPN), and an intranet. The network(s) 106 may be implemented using a wireless network or any kind of physical network implementation known in the art. A user system 104 may be coupled to the host system 102 through multiple networks (e.g., intranet and Internet) so that not all user systems 104 are coupled to the host system 102 through the same network.

As indicated above, the communication services enable subscribers to sustain personal relationships with loved ones when they are no longer able to do so due to, e.g., incapacitation or death, via pre-defined communications. As used herein, incapacitation refers to a health condition of an individual whereby the individual is without capacity (physically and/or mentally) to communicate to another individual his/her thoughts or feelings in a meaningful and substantive manner, either through words or actions.

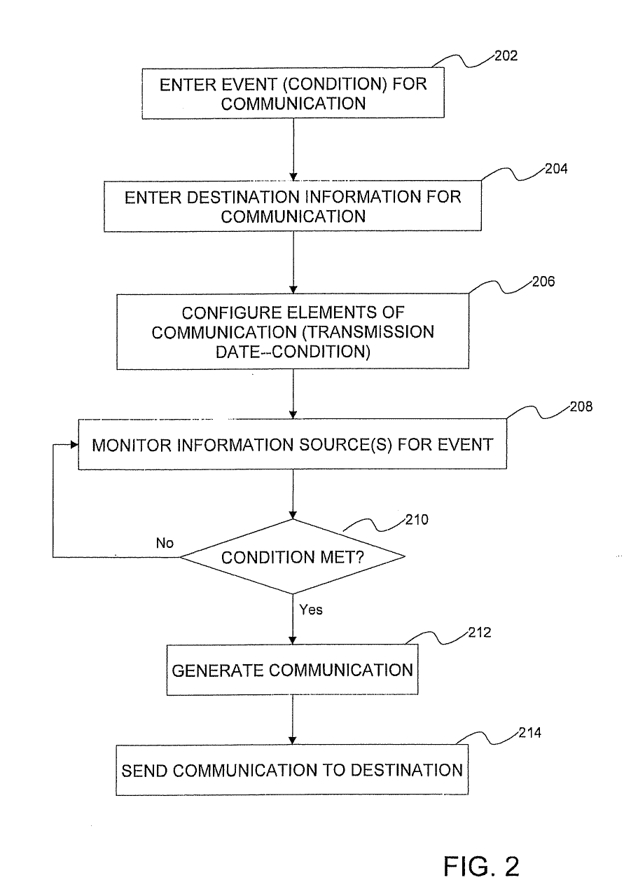

Turning now to FIGS. 2-4, a process and user interface for implementing the communication services will now be described in an exemplary embodiment. As indicated above, the communication service application 110 includes a user interface that is accessible by a subscriber or potential subscriber (e.g., via the user system 104 of FIG. 1). The user interface screen may be accessed by the subscriber via, e.g., a web browser executing on the user system 104. An exemplary user interface screen 300 provided by the communication service application 110 is shown in FIG. 3.

As illustrated in FIG. 2, at step 202, the subscriber is prompted to define an event via options 302 and/or 304 of screen 300. The event options include UPON MY DEATH 302 and UPON MY INCAPACITATION 304. The occurrence of the event (i.e., death or incapacitation) forms a first portion of a condition used by the communication service application 110 for executing a communication configured by the subscriber. In one exemplary embodiment, the subscriber may select both options 302/304. This may be useful, e.g., in situations whereby the subscriber is terminally ill but may become incapacitated prior to his/her death. By selecting both options 302/304, the subscriber is prompted to configure a communication, which may be altered or substituted for another communication, depending upon which of the events occurs first. This is described further herein.

At step 204, the subscriber is prompted to, and provides, destination information for delivery of the communication. The destination information relates to the intended, or target, recipient of the communication. As shown, e.g., in FIG. 3, the subscriber enters a name and address of the recipient in a field 312 provided in a window 310 of the user interface screen 300.

At step 206, the subscriber is prompted to configure various elements of the communication. In an exemplary embodiment, the elements include content (e.g., a message, poem, thoughts, etc.). As indicated above, the communication may be a greeting card. The communication services provide the ability for the subscriber to select from pre-established greeting cards or subscriber-generated greeting cards, collectively referred to herein as “pre-defined” cards or communications. The pre-established greeting cards may be implemented as communication templates (e.g., formatted with front, inside, and back portions, with defined content and images in specified locations on respective front, inside, and back portions). In an exemplary embodiment, the selection of pre-established communications (in this example, greeting cards) is categorized by occasion. As shown in FIG. 3, a window 306 lists various choices of occasions from which the subscriber may select. Additionally, the communication categories, or occasions, may further be classified by recipient (e.g., daughter, wife, mother, husband, etc.). For illustrative purposes, this selection may be made, e.g., via an arrow 308, which when the subscriber scans the arrow 308 via a cursor, the recipient classifications may be listed for selection (not shown). The pre-established greeting cards may include content that may be similar to that found in off-the-shelf greeting cards, except that the content is tailored to the selected event. This is referred to as a “persona;” that is, content that is identifiable with the event (i.e., death or incapacitation) and the subscriber (e.g., father, mother, grandparent, sibling, etc.). For example, if the communication is configured to be transmitted to a recipient after the subscriber has passed on, the content may include words of comfort that suggest, e.g., the subscriber is “watching over” the recipient or “will be reunited” at some future time. Likewise, if the event is incapacitation, the content of the pre-established communication may be tailored to the subscriber's condition.

If the subscriber wishes to create a customized communication, the communication service application 110 prompts the subscriber to enter configuration elements, such as, a personal message or a photograph uploaded to the communication services.

In another exemplary embodiment, the communications may be configured for REGRETS, as shown in the window 306 of FIG. 3. This feature enables subscribers to create customized communications that convey any regrets the subscriber has with respect to a recipient of the communication (e.g., “I am sorry that I did not spend more time with you.”)

As indicated above in step 206, the subscriber is prompted to configure various elements of the communication. The elements also include a transmission date, which forms a second portion of the condition for executing the communication. For example, the transmission date may coincide with a birthday of the recipient or a holiday. In an exemplary embodiment, the transmission date accounts for any anticipated delays associated with postal mail services. For example, the transmission date for a birthday card may be five days before the actual birthday noted in the subscriber record to ensure timely delivery. The transmission date is entered by the subscriber in field 314 of window 310. In an exemplary embodiment, the transmission date does not include a ‘year’, but is entered as a month and day only.

The communication services may offer additional custom options for the subscriber. For example, the subscriber may be prompted to upload a handwritten signature for enhanced personalization of the communication. This feature is shown in field 318 of window 310 in FIG. 3. If the subscriber does not select this feature, he/she is prompted to enter a printed signature in a field 316. This information, or alternatively, the uploaded handwritten signature, is transferred to the communication, as described further herein.

In an exemplary embodiment, the communication services prompt the subscriber to enter additional information for facilitating the features and functions of the services described herein. For example, once the subscriber enters the information in the window of user interface screen 300, the communication services application 110 presents another window 400 to the subscriber, as shown in FIG. 4. The subscriber is prompted to enter a name in a field 402 and an email address in a field 404. The email address of the subscriber may be used by the communication services as one of the means for determining incapacitation or death of the subscriber, as will be described further herein. The subscriber is also prompted to enter one or more electronic sources of information (e.g., a local newspaper, a URL of a local newspaper, funeral home, or other source that is likely to publish the obituary of the subscriber) in a field 406. This is an optional feature that enables the monitor component of the communication services application 110 to periodically search obituaries in one or more electronic databases provided by the local newspaper (e.g., external information source 120B shown in FIG. 1) and any number of other relevant databases. The subscriber is further prompted to enter trusted contact information in fields 408-414, including name, address, email, and telephone information. This is also an optional feature, which may be used to confirm or verify the occurrence of an event (e.g., incapacitation or death). The trusted contact may be a spouse, close friend, or other individual provided by the subscriber. In order to facilitate accurate detection of the event occurrence, the communication service application 110, via the user interface, may prompt the subscriber to enter additional information, such as a subscriber middle name, subscriber birth date, or other identifying information that distinguishes the subscriber from other individuals.

The information is saved in a subscriber record in the storage device 108. A database of subscriber records may be searched by the communication services application 110 to ascertain transmission dates (e.g., via field 314 of FIG. 3), which form the second portion of the condition as described herein.

At step 208, the monitor component 111 of the communication service application 110 monitors one or more sources of information for the event. As described above, if the event is death, the source of information monitored may be a master social security database of deceased persons (e.g., information source 120A of FIG. 1). In an exemplary embodiment, the monitoring is performed on a frequent basis to optimize the communication services' ability to determine the occurrence of the event. Alternatively, or in addition thereto, if subscriber supplied an electronic source of information e.g., a local newspaper, or information source 120B, the monitor component of the communication services application 110 periodically searches this source 120B to determine the occurrence of the event. The first portion of the condition identified in step 202 is satisfied when, in response to the monitoring of either of sources 120A and 120B, the subscriber's name or other identification matches that found in the source(s) 120. By including the information source 120B in the monitoring, the communication services enable redundancy in tracking the occurrence of the event, thereby providing an additional measure of reassurance to the subscriber that the event's occurrence will be autonomously detected by the services without any action taken by a designee or associate of the subscriber.

In contrast, if the event is incapacitation, the monitoring may include evaluating responses, if any, to periodic communications sent to the subscriber (e.g., by the email address provided in field 404 in FIG. 4). As indicated in step 202 and in FIG. 3, the subscriber selects one or both options 302/304 as the event. If the option 304 is selected, the communication service application 110 may query the subscriber for permission to periodically send emails or perform other means of contact (e.g., contacting the subscriber via the email address in field 404 and/or the trusted contact pursuant to the information provided in fields 408-414 of FIG. 4) to assess the current condition of the subscriber. In this embodiment, the first portion of the condition may be satisfied when either of: a threshold amount of time has elapsed without a response from the subscriber and/or trusted contact resulting from periodic email notifications; and a notification of incapacitation condition is provided to the communication services by the trusted contact. With respect to the selected options 302/304, in an alternative exemplary embodiment, the communication service application 110 may look to other sources of information for determining the condition of the subscriber. For example, in FIG. 4, the window 400 provides a means for the subscriber to sign up for a mailing list via a field 416 and a community forum of the communications services via a field 418. The mailing list may provide a means by which the communication services send information about new greeting cards offered, special offers, or other information. The community forum may be an online community of subscribers sponsored by the communication services for enabling subscribers to seek information, moral support, or companionship with other subscribers who may have common diagnoses. If the subscriber is an active member of the forum (i.e., the subscriber frequently and consistently communications via the forum), the communication service application 110 monitor component 111 may track the activities conducted on the forum to determine the continued presence, or absence, of the subscriber. The results of this tracking may be used in conjunction with other methods (e.g., periodic emails to the subscriber, periodic review of the mailing list, etc.) to confirm or verify the condition of the subscriber.

Another advantage of obtaining an email address for the subscriber is so that the communication service application 110 can prompt the subscriber to periodically review and validate the continued accuracy of the information previously provided by the subscriber, e.g., the recipient to which the communication is targeted (e.g., to identify whether the recipient pre-deceased the subscriber), address information of the destination (e.g., to identify a new residence of the recipient); and contact information of the subscriber (e.g., to maintain up-to-date contact information used in assessing the condition of the subscriber).

Turning back to FIG. 2, at step 210, it is determined whether the condition has been met (e.g., the event (death/incapacitation) and transmission date in the field 314). If so, the communication service application 110 generates the communication using the configured elements. The communication may also include additional information. For example, the communication may include a description of the communication service that identifies the intent of the subscriber in initiating the communication with respect to the recipient of the communication (i.e., to explain how the subscriber prepared the communication in anticipation of death or incapacitation). In addition, since the communication services are designed to provide comfort to individuals when a loved one has passed on or has become incapacitated, it is understood that such reminders may not be readily welcomed by certain individuals. Accordingly, the communication services may provide in the communication an opt out instruction for enabling a recipient of the communication to forego future communications from the subscriber.

At step 214, the communication service application 110 sends, on the transmission date (or within a time frame prior to the date to ensure timely delivery), the communication to the destination.

As indicated above, both options 302/304 in the user interface screen 300 of FIG. 3 may be selected by a subscriber. When both options 302/304 have been selected, and it has been determined by monitor component 111 that the first portion of the condition has been met (i.e., the person has become incapacitated) but before the second portion of the condition has been met (i.e., the transmission date), the monitor component 111 periodically searches one or more of the external sources of information 120A-120B to identify a potential change in the event (i.e., the person has passed away). Upon determining the subscriber is deceased, the communication services application 110 prepares an alternative communication to the destination that includes content directed to the change in the event.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

What is claimed is:

1. A method for implementing a communication service, the communication service providing customized communications on behalf of subscribers to the communication service, the method comprising:
defining an event, the occurrence of which forms a first portion of a condition for executing a communication;
providing a destination for delivery of the communication;
configuring elements of the communication, the elements including content and a transmission date, the transmission date forming a second portion of the condition for executing the communication;
periodically monitoring a source of information for the event; and
upon determining the condition has been met:
generating the communication using the configured elements; and
sending, on the transmission date, the communication to the destination.

2. The method of claim 1, further comprising:
prompting the subscriber to provide an electronic source of information to search for the event, the electronic source of information publishing obituaries;
wherein the first portion of the condition is the death of the subscriber, and the source of information includes at least one of the electronic source of information provided by the subscriber and a master database listing of deceased individuals.

3. The method of claim 1, wherein the event is a chronic, incapacitating health condition of the subscriber, and the monitoring includes evaluating responses, if any, to periodic communications sent to the subscriber;
wherein the first portion of the condition is satisfied when at least one of:
a threshold amount of time has elapsed without a response from the subscriber; and
a notification of the chronic, incapacitating health condition is provided to the communication service by a trusted source, the trusted source comprising an individual designated by the subscriber.

4. The method of claim 3, wherein, responsive to the first portion of the condition being met but before the second portion of the condition is met, the method further comprises:
searching at least one of an electronic source of information provided by the subscriber and a master database listing of deceased individuals to identify a potential change in the event, the electronic source of information publishing obituaries; and
upon determining the subscriber is deceased, responsive to the searching, preparing an alternative communication to the destination, the alternative communication including content having a persona corresponding to the change in the event.

5. The method of claim 3, wherein the communication includes at least one of a greeting card pre-selected by the subscriber from a number of greeting cards provided by the communication service; and a personal greeting card generated by the subscriber; and
wherein the greeting cards provided by the communication service include content having a persona corresponding to the event.

6. The method of claim 5, wherein the greeting cards include content associated with an occasion, and the configurable elements of the communication include at least one of:
a handwritten signature of the subscriber, the handwritten signature electronically uploaded to the communication service;
a personal photograph uploaded by the subscriber to the communication service; and
a personal message provided by the subscriber.

7. The method of claim 3, wherein the periodic communications to the subscriber further include prompts to validate the continued accuracy of:
a recipient to which the communication is targeted;
address information of the destination;
contact information of the trusted source; and
contact information of the subscriber.

8. The method of claim 1, wherein the sources of information include at least one of a mailing list and a communication forum of the communication service, and the monitoring includes periodically reviewing the mailing list and communication forum activity, and responsive thereto, determining a current activity status of the subscriber with respect to the communication service, and validating the event based upon at least the current activity status.

9. The method of claim 1, wherein generating the communication further includes a providing a message from the communication service, the message containing at least one of:
a description of the communication service that identifies the intent of the subscriber in initiating the communication with respect to a recipient of the communication; and
an opt out instruction for enabling a recipient of the communication to forego future communications from the subscriber.

10. A system for implementing a communication service, the communication service providing customized communications on behalf of subscribers to the communication service, comprising:
a computer processing device; and
a communication service application executing on the computer processing device, the communication service application implementing a method, the method comprising:
defining an event, the occurrence of which forms a first portion of a condition for executing a communication;
providing a destination for delivery of the communication;
configuring elements of the communication, the elements including content and a transmission date, the transmission date forming a second portion of the condition for executing the communication;
periodically monitoring a source of information for the event; and
upon determining the condition has been met:
generating the communication using the configured elements; and
sending, on the transmission date, the communication to the destination.

11. The system of claim 10, wherein the communication service application further implements:
prompting the subscriber to provide an electronic source of information to search for the event, the electronic source of information publishing obituaries;
wherein the first portion of the condition is the death of the subscriber, and the source of information includes at least one of the electronic source of information provided by the subscriber and a master database listing of deceased individuals.

12. The system of claim 10, wherein the event is a chronic, incapacitating health condition of the subscriber, and the monitoring includes evaluating responses, if any, to periodic communications sent to the subscriber;
wherein the first portion of the condition is satisfied when at least one of:
a threshold amount of time has elapsed without a response from the subscriber; and
a notification of the chronic, incapacitating health condition is provided to the communication service by a trusted source, the trusted source comprising an individual designated by the subscriber.

13. The system of claim 12, wherein, responsive to the first portion of the condition being met but before the second portion of the condition is met, the method further comprises:
searching at least one of an electronic source of information provided by the subscriber and a master database listing of deceased individuals to identify a potential change of the event, the electronic source of information publishing obituaries; and
upon determining the subscriber is deceased, responsive to the searching, preparing an alternative communication to the destination, the alternative communication including content having a persona corresponding to the change in the event.

14. The system of claim 12, wherein the communication includes at least one of a greeting card pre-selected by the subscriber from a number of greeting cards provided by the communication service; and a personal greeting card generated by the subscriber; and
wherein the greeting cards provided by the communication service include content having a persona corresponding to the event.

15. The system of claim 14, wherein the greeting cards include content associated with an occasion, and the configurable elements of the communication include at least one of:
a handwritten signature of the subscriber, the handwritten signature electronically uploaded to the communication service;
a personal photograph uploaded by the subscriber to the communication service; and
a personal message provided by the subscriber.

16. The system of claim 12, wherein the periodic communications to the subscriber further include prompts to validate the continued accuracy of:
a recipient to which the communication is targeted;
address information of the destination;
contact information of the trusted source; and
contact information of the subscriber.

17. The system of claim 10, wherein the sources of information include at least one of a mailing list and a communication forum of the communication service, and the monitoring includes periodically reviewing the mailing list and communication forum activity, and responsive thereto, determining a current activity status of the subscriber with respect to the communication service, and validating the event based upon at least the current activity status.

18. The system of claim 10, wherein generating the communication further includes a providing a message from the communication service, the message containing at least one of:
a description of the communication service that identifies the intent of the subscriber in initiating the communication with respect to a recipient of the communication; and
an opt out instruction for enabling a recipient of the communication to forego future communications from the subscriber.

19. A computer program product for implementing a communication service, the communication service providing customized communications on behalf of subscribers to the communication service, the computer program product comprising a computer-readable storage medium embodied with computer-readable program instructions, which when executed, cause a computer to implement a method, the method comprising:
defining an event, the occurrence of which forms a first portion of a condition for executing a communication;
providing a destination for delivery of the communication;
configuring elements of the communication, the elements including content and a transmission date, the transmission date forming a second portion of the condition for executing the communication;
periodically monitoring a source of information for the event; and
upon determining the condition has been met:
generating the communication using the configured elements; and
sending, on the transmission date, the communication to the destination.

20. The computer program product of claim 19, further comprising instructions for implementing:
prompting the subscriber to provide an electronic source of information to search for the event, the electronic source of information publishing obituaries;
wherein the first portion of the condition is the death of the subscriber, and the source of information includes at least one of the electronic source of information provided by the subscriber and a master database listing of deceased individuals.

21. The computer program product of claim 19, wherein the event is a chronic, incapacitating health condition of the subscriber, and the monitoring includes evaluating responses, if any, to periodic communications sent to the subscriber;
wherein the first portion of the condition is satisfied when at least one of:
a threshold amount of time has elapsed without a response from the subscriber; and
a notification of the chronic, incapacitating health condition is provided to the communication service by a trusted source, the trusted source comprising an individual designated by the subscriber.
